(19) United States
(12) Patent Application Publication
(10) Pub. No.: US 2006/0238627 A1
(43) Pub. Date: Oct. 26, 2006

(54) Camera apparatus capable of switching reduced guide image upon playback of magnified image, and image displaying method

(75) Inventors: Tsuyoshi Hagiwara, Ome-shi (JP); Tatsuhiko Ikehata, Ome-shi (JP); Tatsuro Abe, Ome-shi (JP); Kei Tashiro, Ome-shi (JP); Toyokazu Aizawa, Sagamihara-shi (JP); Shiro Nagaoka, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/402,827

(22) Filed: Apr. 13, 2006

(30) Foreign Application Priority Data
Apr. 20, 2005 (JP) 2005-122536

(51) Int. Cl. H04N 5/76

(52) U.S. Cl. 348/231.99

(57) ABSTRACT

In an embodiment of a camera apparatus according to the invention, a playback streaming signal which is output from a recording medium and in a compressed state is transferred to a map defined in a memory, the transferred playback streaming signal is decoded by a decoder, and converted to a YUV signal in an image processor, and transferred to a map as a YUV signal, a magnified or reduced image is generated from the YUV signal by an image processor, and stored on a map, the magnified or reduced image prepared on a map is overlaid according to a magnify playback request, the overlaid image is output to seek an output position, and the image is erased by gradually increasing the transmissivity of a reduced image, when an instruction is not input for predetermined time.

### CROSS-REFERENCE TO RELATED APPLICATIONS

This application is based upon and claims the benefit of priority from Japanese Patent Application No. 2005-122536, filed Apr. 20, 2005, the entire contents of which are incorporated herein by reference.

### BACKGROUND

1. Field

The present invention relates to a camera apparatus, which displays a corresponding part of an image before magnifying as a reduced guide image when magnifying and playing a still image or a moving image taken by a camera apparatus, and can select a desired image regardless of an image displaying method.

2. Description of the Related Art

A camera apparatus can record still and moving images in a recording medium, such as a semiconductor memory (a memory card) and a hard disc unit.

A taken image is displayed (played back) in a liquid crystal display provided integrally with a camera apparatus, a display unit capable of displaying a video signal, that is, a display unit used in a personal computer, or an ordinary television set, by the user by operating the camera apparatus.

With the spread of a camera apparatus and a large-screen television set (monitor unit), the user has demanded a function of magnifying and playing a part of a taken image.

Japanese Patent Application Publication (KOKAI) No. 2004-48229 discloses a display controlling method when magnifying and displaying a still image in a digital still camera.

However, the Publication 2004-48229 describes only about magnifying/displaying a still image and a handling method, and does not describes about magnifying/displaying an optional area in a moving image during playback of that moving image.

Further, when an image is magnified and displayed in a full screen, it is impossible to know which part of an original image corresponds to the magnified image displayed now, or the magnification of the magnified image.

The above Publication suggests displaying a reduced whole image (reduced guide image) on a displayed magnified image. Contrarily, in the example of the above Publication, a reduced guide image is always displayed on a displayed magnified image, and a part of the displayed magnified image is hidden (not seen).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are exemplary diagrams each shows an example of a camera apparatus capable of recording still and moving images and sounds, according to an embodiment of the invention;

FIG. 2 is an exemplary diagram showing a control system of the camera apparatus according to an embodiment of the invention shown in the FIGS. 1A and 1B;

FIGS. 3A to 3C are exemplary diagrams each shows an example of the camera apparatus shown in FIGS. 1A, 1B and 2, explaining an example of displaying a reduced image (full-size thumbnail) in a magnified display mode;

FIG. 4 is an exemplary diagram showing an example of the camera apparatus shown in FIGS. 1A, 1B and 2, explaining an example of an image processor for displaying a reduced image (full-size thumbnail) in a magnified display mode; and

FIG. 5 is an exemplary flow chart explaining an example of operation for erasing a reduced guide image at an optional timing in a magnified display mode.

### DETAILED DESCRIPTION

Various embodiments according to the invention will be described hereinafter with reference to the accompanying drawings. In general, a camera apparatus according to the present invention, a playback streaming signal which is output from a recording medium and in a compressed state is transferred to a map defined in a memory, the transferred playback streaming signal is decoded by a decoder, and converted to a YUV signal in an image processor, and transferred to a map as a YUV signal, a magnified or reduced image is generated from the YUV signal by an image processor, and stored on a map, the magnified or reduced image prepared on a map is overlaid according to a playback request, the overlaid image is output to seek an output position, and the image is erased by gradually increasing the transmissivity of a reduced image, when an instruction is not input for predetermined time.

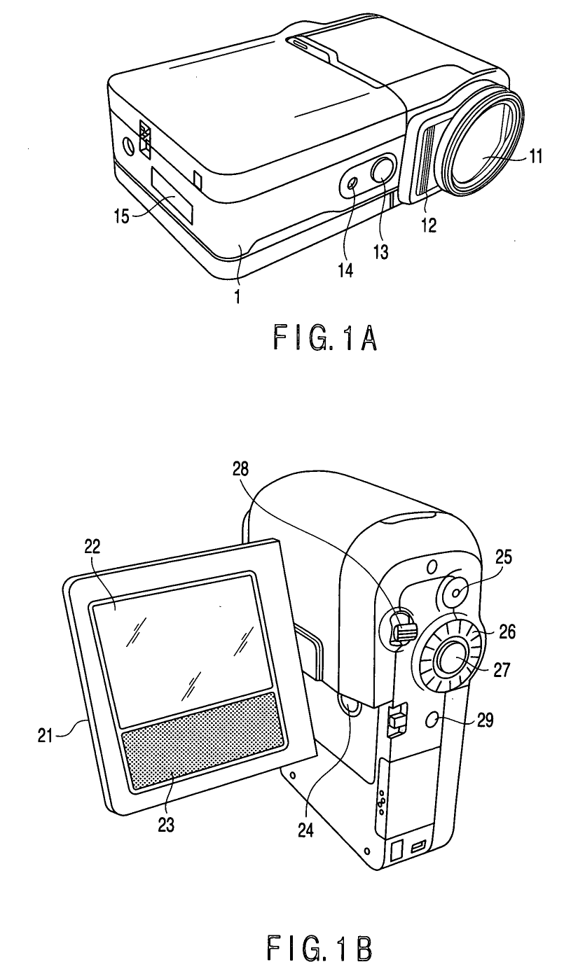

FIGS. 1A and 1B show schematic illustrations of an electronic camera apparatus capable of recording still and moving images and sounds, to which an embodiment of the invention are applicable.

FIG. 1A shows a camera apparatus (an image pickup apparatus) 1 viewed from the camera lens side.

The electronic camera apparatus 1 has a camera lens 11, a flash 12, a shutter button 13 (for a still image), and a remote control receiver 14. The camera apparatus 1 also has an adapter connector (a connection terminal) 15 used for connection with a personal computer and an external power supply (a charger).

FIG. 1B shows the electronic camera apparatus 1 viewed from the opposite side of the camera lens 11.

The camera apparatus 1 has a liquid crystal monitor (LCD panel) 22 and a speaker 23 provided integrally with a frame 21 functioning also as a main power switch. The electronic camera apparatus 1 also has a main power switch 24 at a fixed position, which is turned off at the position where the frame 21 is closed (housed at a fixed position of the main body of the electronic camera).

The electronic camera apparatus 1 has, at predetermined positions, a record button 25 capable of inputting instructions (commands) to start and stop recording a moving image, a jog (JOG) dial 26 capable of inputting instructions (control commands) to input operation modes and conditions and select decisions, a set (OK) button 27 capable of inputting an instruction (a control command) to determine (execute) the instruction selected (guided) by the jog dial 26, a zoom bar 28 capable of inputting a control signal for zoom operation to change the angle of an image (the angle to take a picture of a subject) to be taken by the camera lens 11, and a menu button 29 used to input a control command to display a menu screen.

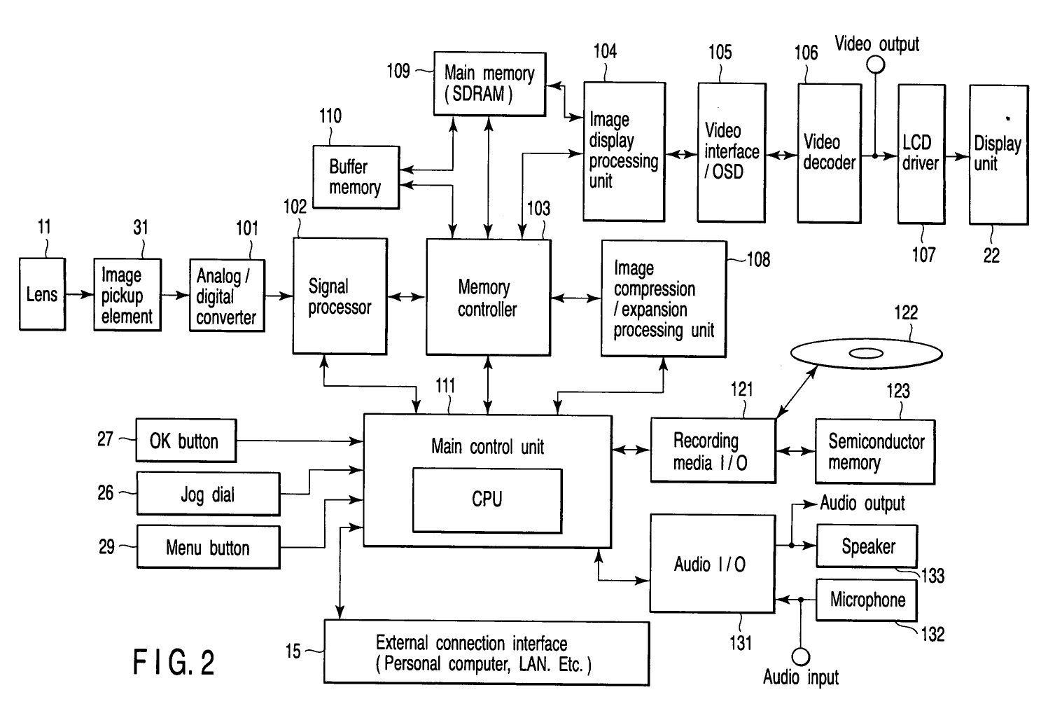

FIG. 2 shows an example of a control system of the camera apparatus shown schematically in FIGS. 1A and 1B.

A subject image taken by the camera lens 11 is focused on an image forming plane of the image pickup element 31, or a CCD sensor, for example, and converted to an analog signal (taken image data). The subject image is converted to an electric signal by an image pickup element (CCD sensor) 31, based on light and shade, converted to a digital signal by an analog/digital (A/D) converter 101, and input to a camera signal processing circuit 102.

The camera signal processing circuit 102 performs gamma correction, color signal separation or white balance adjustment for the taken image data converted to a digital signal by the A/D converter 101.

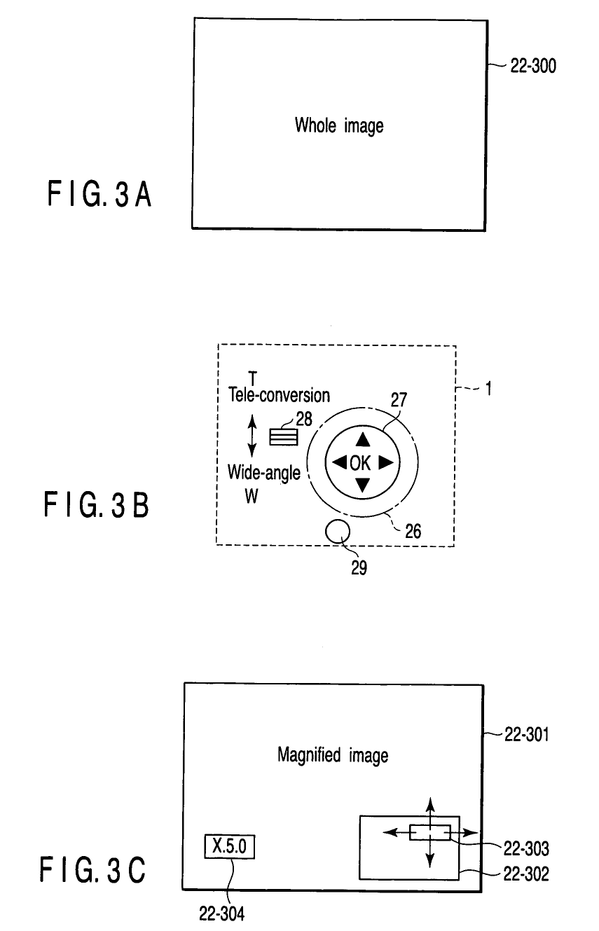

The taken image data output from the camera signal processing circuit 102 is supplied to the image display processing unit 104 through a memory controller 103. The image display processing unit 104 includes a video interface/on-screen-display (OSD) processing unit 105 and a video decoder 106, and generates an image signal for display output, that is, a video signal. As explained later with reference to FIGS. 3B and 3C, the video interface/OSD 105 is used to display a display frame or a sub-screen when displaying the magnified image of an optional part of the image displayed in the LCD 22 within a display frame or a sub-screen, for example. An image to be overlaid through the OSD processor 105 is magnified or reduced by transfer of the data between the memory controller 103 or image compression/expansion processing unit 108 described later and a buffer memory 110 or main memory 109 to be explained later.

The output of the video decoder 106 is input to a liquid crystal panel driver (LCD Driver) 107, and displayed in an LCD panel 22 (hereinafter called LCD) mounted in the frame 21 (refer to FIG. 1B).

The taken image data output from the camera signal processing circuit 102 is compressed in a compression/expansion processing unit 108, when recording, and recorded in a main recording medium, for example, a hard disc unit 122 (hereinafter abbreviated as HDD) or an attached removable recording medium, for example, a memory card 123, or a nonvolatile memory, through a media controller 121, under the control of a main control unit (CPU) 111. The compression/expansion processing unit 108 compresses a still image by a known method such as JPEG, and a moving image (a non-still image) by MPEG. The memory card 123 may use a semiconductor memory called SD card (registered trademark) and mini-SD (registered trademark). Namely, an optical disc may be used instead of the HDD 122.

When playing an image recorded in the HDD 122 or memory card 123, an image read from the HDD 122 or memory card 123 is expanded in the compression/expansion processing unit 108, supplied to the image display processing unit 104 through the memory controller 103, and displayed in the LCD 22.

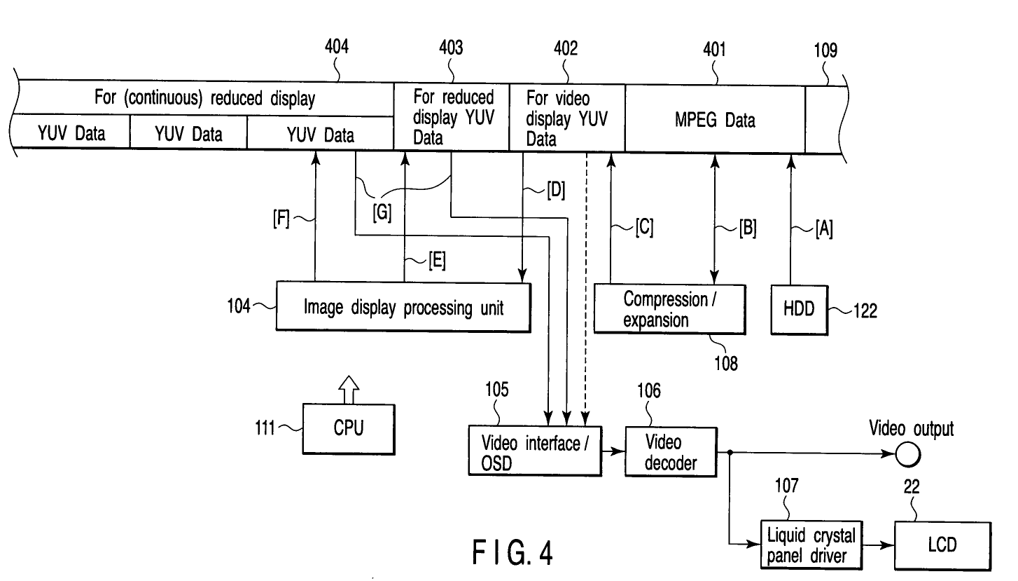

The image display processing unit 104 generates various images to be displayed in the LCD 22, for example, reduced images to be displayed as a list, by using a main memory (memory circuit, or SDRAM) 109 and buffer (work) memory 110 connected to the memory controller 103 (as explained in detail later with reference to FIG. 4). The generated reduced images are overlaid on an icon generated by the OSD 105 and various marks used to indicate operations, before displayed in the LCD 22. A part of the recording area of the main memory 109 may be assigned to the buffer (work) memory 110.

The main memory 109 and buffer memory 110 are used for reducing image data (generating a thumbnail image), editing in edit mode and changing the sequence of image file, though not explained in detail.

The buffer memory 110 can save image data for one screen or two or more screens. The image data saved in the buffer memory 110 is input to the image display processing unit 104 through the memory controller 103, and can be sequentially played (monitored) in the LCD 22 (the state of editing the image can be confirmed).

The camera apparatus 1 can take in sound/audio data through a microphone 132 connected to an audio input/output processor 131 or an audio input terminal (Audio In), when editing or shooting. The audio data is correlated with the taken image data and recorded in a predetermined area of the HDD 122 or memory card 123.

The recorded audio data is read with the taken image data from the HDD 122 or memory card 123, and output to a speaker 133 or audio output terminal (Audio Out), when playing an image. Of course, the audio output from the speaker 133 can be eliminated (the output level can be set to “0”) when playing an image.

In the HDD 122 as a recording medium, according to the capacity, the recordable number of still images or the time to record moving images (the number of titles) reaches several 100 to several 1000. Thus, a high speed is demanded to feed the recorded images or titles forward and backward.

Therefore, the jog dial 26 and OK button 27 permit selection of many images or titles and setting of operation modes without a stress. (An easy-to-use switch such as the jog dial 26 is useful when specifying an image by continuously searching many images or titles.) The contents input by the jog dial 26 (by the user operation), operation states of the camera apparatus 1, or display of the menu screen by the menu button 29 are combined through the CPU 111, memory circuit 109, image display processing unit 104, video interface and OSD processor 105, and displayed in the LCD 22.

The OK (set) button 27 gives the CPU 111 information that the button 27 is pressed (ON/OFF signal is input). Based on the ON/OFF signal input from the information (the button 27), the CPU 111 determines the image/title or mode selected by the jog dial 26, and plays the image/title or sets the mode.

The jog dial 26 gives the CPU (main control unit) 111 information about the rotation angle and speed. The CPU 111 can control the (next) image display speed from the information.

The OK (set) button 27 is placed coaxially (concentrically) with the center of rotation of the job dial 26. The OK (set) button 27 can input the above-mentioned ON signal when pressed substantially toward the center (in the axial direction), and can input a control command (instruction) to scroll an image displayed in the LCD 22 in the pressed direction, when pressed in one of four directions (generally called “up/down/left/right”) dividing the circumference equally into four parts.

Explanation will now be given on the characteristic configuration and image data processing method in the camera apparatus of the invention.

For example, when start of magnified display is instructed through a user instruction input part represented by optional switch or button of the camera apparatus 1, for example, a zoom bar 28 in the state that the whole image 22-300 of a playback object image (moving image) is displayed in the LCD 22 (extracted and explained in FIG. 3B) during playback of an image, as shown in FIG. 3A, the image displayed in the LCD 22 is switched to a magnified image display screen 22-301 as shown in FIG. 3C.

On the magnified image display screen 22-301, a reduced guide image 22-302 (may be called a full-size thumbnail) and a magnify position mark or frame 22-303 indicating an area magnified and displayed now as a magnified image display screen 22-301 are simultaneously displayed. At an optional position in the magnified image display screen 22-301, the magnification of the displayed magnified image which is defined by the OSD processor 105 based on the position of the zoom bar 28 and set by the compression/expansion processing unit 108 under the control of the main control unit 111, is displayed.

When the user presses the OK button 27 and instructs (inputs) to move a magnify object area to one of the up/down/left/right directions while a magnified image is being displayed, the magnify position mark 22-303 is moved within the displayed reduced whole image 22-302. The area to be magnified is changed by this operation.

When the zoom bar 28 is moved to one of T (Tele-conversion) or W (Wide-angle) sides, a corresponding magnification is instructed and a magnification of a magnified image is changed.

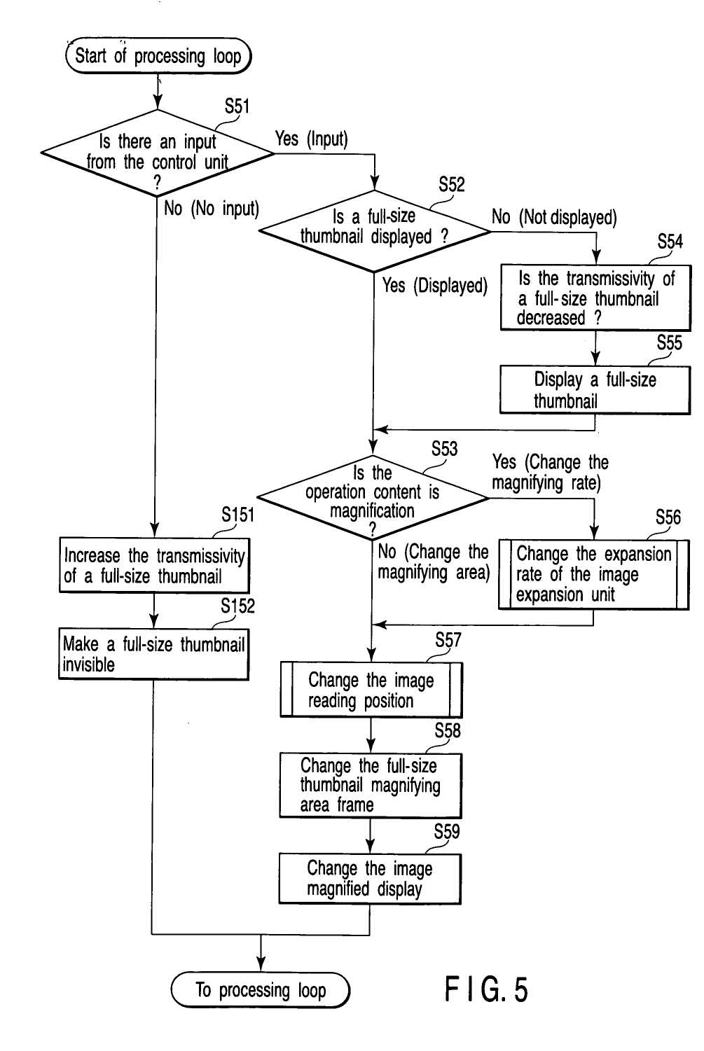

The reduced guide image (whole) 22-302 and magnify position mark 22-303 are erased when specified time passes after stop of the operation of the zoom bar 28 or OK button 27 (when a not-shown counter or timer counts 3-5 seconds, for example). Until a thumbnail image (reduced guide image) is completely erased, the density of an image displayed as a reduced guide image is gradually decreased as the time passes (the transmissivity of a reduced guide image is gradually increased), as explained later with reference to FIG. 5. Of course, it is possible to set to erase a reduced guide image by detecting turning on of the OK button 27, for example.

As already explained, when start of a magnified display mode is instructed by the zoom bar 28, for example, a MPEG compressed playback streaming signal output from the HDD 105 (or the memory card 106) is transferred to a map 401 of the SDRAM (memory circuit) 104, as shown in label [A] of FIG. 4. Namely, an image data of a magnifying area is obtained from an image file of an image to be magnified and displayed.

Then, in label [B] and label [C], the data is decoded by the compression/expansion processing unit (MPEG codec) 108, and converted to a YUV signal for video display, and transferred to a map 402 of the main memory (SDRAM) 109, as a YUV signal. Namely, a magnifying image data is expanded, and a video display data corresponding to a magnifying image is generated.

The YUV signal, when displayed without modifying, is given OSD (here, the data corresponding to the frame of the reduced guide image 22-302 in the display 22-301 and the frame of the magnify position mark 22-303 in FIG. 3C) in the video interface and OSD processor 105, converted to a video signal by the video decoder 106, and displayed in the LCD 22 through the liquid crystal panel driver 107. When displaying in an externally connected display unit, a signal output to a video output (Video Out) terminal can be used.

The YUV signal is input to the image display processing circuit 104 in order to generate a YUV data used for displaying a reduced guide (label [D]). Namely, a reduced data for a reduced guide image is obtained from the data of whole image.

The image display processing circuit 104 is an engine used to magnify or reduce an image (for full-size display in a reduced guide image) and to change an image density (transmissivity), and high-speed processing is possible. In addition, existing techniques, such as bi-linear or bi-cubic interpolation and filtering are possible to increase the image quality. Most of these techniques have been used originally for magnification and reduction of a still image.

In the image display processing circuit 104, a file including multiple still images used for displaying a single reduced image or a reduced moving image is stored in maps 403 (label [E]) and 404 (label [F]) of the memory circuit 109, respectively. Images changed in transmissivity for reduced display is given a specified step of density (transmissivity) in order to gradually decrease the density of an image displayed as a reduced guide image during every period of specified time until a reduced guide image is completely erased as explained before.

Namely, displaying a magnified or reduced image or an image with different transmissivity (density) in this invention is performed by preparing reduced still images from an optional moving image, and sequentially transferring (outputting) them according to a transfer request, whenever requested. This is simple and low cost. With the recent high-speed (decreased processing speed) hardware structure (SDRAM), an image can be processed in real time if the size is standard. An image displayed in the LCD 22 through the video interface/OSD processor 105, or data corresponding to the frame of the sub-screen (reduced guide screen) 22-302 and the frame of the magnify position mark 22-303 on the display 22-301 of FIG. 3 (c) is sequentially moved when movement to the up/down/left/right is instructed (input) through the OK button 27. At the same time, the area of an original image to be magnified according to the moving range of the magnify position mark 22-303 is changed, and the corresponding magnified or reduced images are sequentially stored in the maps 403 (label [E]) and 404 (label [F]) of the SDRAM 109.

Thereafter, the still image prepared in the maps 403 (label [E]) and 404 (label [F]) of the main memory (SDRAM) 109 in the above process and the file [F] including the multiple still images used for displaying a reduced moving image are overlaid through the video interface and OSD processor 105, and output to the video decoder 106 (label [G]). In this time, the magnification display 22-304 generated by the OSD processor 105 is also input to the video decoder 106.

Therefore, the magnification display 22-304, the reduced guide image 22-302, and the OSD image (frame) 22-303 laid on within the reduced guide image 22-302 are simultaneously displayed on the image 22-301 already magnified and displayed in the LCD 22, as shown in FIG. 3C.

Namely, when displaying the reduced guide image 22-302, transfer the corresponding data or previously prepared images in a buffer (map) of a specified display position sequentially to the video decoder 106, thereby the reduced guide image 22-302 is displayed within the magnified image display area 22-301. The above-mentioned magnified and reduced images utilize the high-speed image data transfer between the SDRAM (main memory) 109 and video decoder 106, and can be easily realized by the above-mentioned simple method without requiring a special configuration for displaying a reduced guide image and changing transmissivity.

When the OK button 27 is pressed to input an instruction to change the relative positions between the magnification change part displayed on a moving image displayed in the display unit and the moving image displayed in the display unit, a magnified image corresponding to the magnification change part is changed according to the relative positions instructed to be changed. Namely, when the user inputs any instruction or an input signal (operates the zoom bar or button), the magnification of image is changed or the area to display a magnified image is changed under the control of the CPU (main control unit) 111 according to the input (instruction).

As already explained, when a control signal is not input for predetermined time through the zoom bar 28 or OK button 27, a magnified display mode is reset and the reduced guide image 22-302, display frame 22-303 and magnification display 22-304 are erased.

In this time, an image given a specified step of density (transmissivity) to gradually lower the density of the image displayed as a reduced guide image is sequentially transferred to the video decoder 106, until the reduced guide image is completely erased at each time when predetermined time elapses. This realizes display (output) of an image with an increased transmissivity (decreased density) and ensured operability without deteriorating the visibility of magnified image.

The image display by gradually increasing the transmissivity (gradually decreasing the density) at the end of the above-mentioned magnified display mode can also be achieved by changing a luminance signal, for example, when images for reduced display previously generated by the image display processing unit 104 are output to the video decoder 106, for example. (The image display can also be realized by thinning out a black signal at a specified ratio.)

Erasing a reduced guide image is not limited to the above-mentioned method of changing the transmissivity (density) of a reduced guide image. It is also possible to collect a specified number of pixels as a block and define several matrixes, and erase randomly or in a specified order by units of matrix. It is also possible to make a matrix belt-like (1 line (optional direction)×width or length), give a time difference (when erasing) in the direction orthogonal to the length (width) direction, and erase a reduced guide image from one direction.

FIG. 5 shows an example of operation for erasing a reduced guide image at an optional timing in a magnified display mode. In FIG. 5, steps S51, S151 and S152 relate to a method of selectively clearing display of a reduced guide image (full-size thumbnail image), when the user does not input a control signal for predetermined time (e.g., 3-5 seconds) in the magnified display mode displaying a reduced guide image, that is, based on whether the user operates or not during the magnified display mode. When the user does not input a control signal, that is, when the user finishes operation, a reduced guide image is not displayed and a magnified image itself can be easily confirmed thereby (the visibility is increased).

The main control unit (CPU) 111 monitors the user operation, that is, input of a control signal through any switch or button (S51). When any input (instruction) is detected (S51-Y), the main control unit judges whether a full-size thumbnail image (reduced guide image) is displayed, that is, whether a magnified display mode is set (S52).

When a magnified display mode has been executed (S52-Y), the main control unit checks whether the operation (input) by the user is to change magnification or to change a magnifying area (object area) (S53).

When the input (instruction by the user) is to change a magnifying area in step S53 (S53-N), the position of an image to be read from an image file is changed in the display image processing unit 104 already explained in FIG. 4 (S57).

Then, the position of the magnify area frame 22-303 (refer to FIG. 3C) to be magnified and displayed corresponding to a full-size thumbnail, that is, the position of a magnified display part of a whole image is changed (S58).

Next, the area of an image to be magnified and displayed (the area to be displayed as a magnified image) is changed (S59).

Contrarily, when the user demands to display a full-size thumbnail image in step S52 (S52-N), an image data with a low transmissivity (high density) among the prepared YUV image data for reduced display is transferred to the video decoder (S54), and a full-size thumbnail image is displayed (S55).

Further, when the user operation (instruction) input in the above step S53 in the state that the magnified display mode has been executed in S52-Y or step S55 is to change the magnification (S53-Y), the magnification of the image data read from the image file is changed by the compression/expansion processing unit 108 (S56).

Contrarily, when the user operation (input instruction) is suspended for predetermined time in the state that the magnified display mode has been executed and a magnified image, full-size thumbnail image, magnify position and magnification are displayed (S51-N), the reduced display images with different transmissivity explained in FIG. 4 are sequentially displayed, thereby the transmissivity of the full-size thumbnail (reduced guide image) 22-302 is increased (S151).

After predetermined time passes, the full-size thumbnail image is erased (S152).

As explained hereinbefore, in the present invention, the switching of magnified display is possible, and when the change of magnification and magnified display area is instructed, a reduced guide image is displayed.

In this case, it is possible to display a thumbnail (reduced guide image) without deteriorating operability and visibility, for example, by gradually lowering the transmissivity of a reduced guide image to a magnified display image (that is, to display gradually).

A reduced guide image (thumbnail) includes the magnified display frame 22-303 indicating the area magnified now. As the magnification or magnified display area is changed, the size and position of the magnified display frame in the reduced guide image are changed.

When an operation such as changing magnification or magnified display area is completed (predetermined time passes after the last input instruction), a reduced guide image is set invisible (a magnified display mode is finished).

In this case, the transmissivity of a reduced guide image to a magnified display image is gradually increased (that is, a reduced image is gradually erased).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, embodiment of the invention is applicable also to a video camera using a tape-like medium as a recording medium without modifications. A camera may be a still camera for shooting (recording) mainly a still image, using a large capacity memory card as a main recording medium, and an optional external recording medium as an auxiliary recording medium.

What is claimed is:

1. A camera apparatus comprising:
a recording unit which holds an image;
a display unit which displays an image held by the recording unit;
a display processing unit which overlays identification information indicating a magnification change part on an image displayed in the display unit;
an image magnify processing unit which provides a magnified image corresponding to the magnification change part overlaid on the image displayed in the display unit;
a display control unit which changes a magnified image corresponding to the magnification change part according to an instruction to change the relative positions, when an instruction is given to change the relative positions between the magnification change part overlaid on the image displayed in the display unit and the image displayed in the display unit; and
an overlay image control unit which changes the transmissivity of the identification information and the image of the magnification change part, when predetermined time passes after the change of the relative positions is input to the display control unit or the change of the magnification is input to the image magnify processing unit.

2. The camera apparatus according to claim 1, wherein the overlay image control unit increases the transmissivity of the identification information and magnification change part, when predetermined time passes after the input to change the relative position to the display control unit or the image magnify processing unit.

3. The camera apparatus according to claim 2, wherein the overlay image control unit increases the transmissivity of the identification information and the image of the magnification change part, and make the image invisible (completely transparent) when predetermined time passes after the change of the relative positions is input to the display control unit or the change of the magnification is input to the image magnify processing unit.

4. The camera apparatus according to claim 2, wherein the overlay image control unit sequentially transfers reduced images which are defined by the identification information and changed the transmissivity at a processing ratio, to the display unit.

5. The camera apparatus according to claim 3, wherein the overlay image control unit sequentially transfers reduced images which are defined by the identification information and changed the transmissivity at a processing ratio, to the display unit.

6. The camera apparatus according to claim 1, wherein the overlay image control unit overlays the identification information and the image of the magnification change part on a magnified image displayed by the magnified image display unit, when an input is given to the image magnify processing unit in the state display of a magnified image is not instructed to the magnified image display unit.

7. A camera apparatus comprising:
a lens which takes in recording information as a change of light;
an image signal generator which generates an image corresponding to the information taken in through the lens;
a recording unit which holds an image;
a display unit which displays an image held by the recording unit;
a display processing unit which overlays identification information indicating a magnification change part on an image displayed in the display unit;
an input unit which is configured to input an instruction to provide a magnified image of an image corresponding to the magnification change part overlaid on the image displayed in the display unit;
an image magnify processing unit which provides an image with an input magnification, when the input unit inputs a change of magnification of a magnified image corresponding to the magnification change part overlaid on the image displayed in the display unit;
a position input unit which instructs to change the relative positions between the magnification change part overlaid on the image displayed in the display unit and the image displayed in the display unit;
a display control unit which changes a magnified image corresponding to the magnification change part according to an instruction to change the relative positions, when the position input unit instructs to change the relative positions between the magnification change part overlaid on the image displayed in the display unit and the image displayed in the display unit; and
an overlay image control unit which changes the transmissivity of the identification information and the image of the magnification change part to a substantially invisible level over predetermined time, when predetermined time passes after the change of the relative positions is input to the display control unit or the change of the magnification is input to the image magnify processing unit.

8. An image displaying method comprising:
transferring a playback streaming signal which is output from an image holder and in a compressed state, to a map;
decoding the transferred playback streaming signal, converting the signal to a YUV signal, and transferring the signal to a map as a YUV signal;
generating a magnified or reduced image and reduced images with different transmissivity from a YUV signal, and storing the images on a map;
overlaying a magnified or reduced image prepared on a map according to a playback request, and outputting the overlaid image to seek an output position; and
outputting reduced images with different transmissivity sequentially over predetermined time, when predetermined time passes after the instruction to change the position or magnification of the overlaid image.
